(19) United States
(12) Patent Application Publication
(10) Pub. No.: US 2006/0203946 A1
(43) Pub. Date: Sep. 14, 2006

(54) Channelized receiver system with architecture for signal detection and discrimination

(75) Inventors: Thomas A. Moch, Owego, NY (US); Douglas N. McMartin, Apalachin, NY (US)

Correspondence Address: Lockheed Martin Corporation;c/o WOLF, GREENFIELD & SACKS, PC, FEDERAL RESERVE PLAZA, 600 ATLANTIC, BOSTON, MA, 02210-2206, US

(73) Assignee: Lockheed Martin Corporation, Bethesda, MD (US)

(21) Appl. No.: 11/078,237

(22) Filed: Mar. 11, 2005

(51) Int. Cl. H04B 1/10

(52) U.S. Cl. 375/349

(57) ABSTRACT

A channelized receiver with improved signal detection and discrimination. Separate threshold values are computed for each channel in the receiver. The values are computed dynamically in response to detected signal levels. In channels where energy is likely the result of spectral “splatter” from other channels, the threshold is set relatively high. In other channels, the threshold may be set relatively low, thereby increasing the chances that the receiver will detect relatively low level signals while reducing the probability that splatter or other anomalies will be falsely identified as a signal.

### FIELD OF INVENTION

The invention relates generally to communication systems, and more particularly to channelized receivers.

### BACKGROUND OF INVENTION

Signal detection systems for scanning a wide range of electromagnetic frequencies and detecting signals of interest are employed in numerous military and commercial applications. A common approach to wide band signal detection involves channelized receivers. In a channelized receiver, the frequency spectrum of interest is partitioned into numerous channels. Each channel has a bandwidth much narrower than the total frequency spectrum of interest. By observing the outputs of all the channels, signals occurring at any frequency in the spectrum of interest may be detected.

A typical channelized receiver comprises a filter bank, with each filter possessing a passband spanning some portion of the frequency spectrum of interest. In the aggregate, the passbands of the filters in the filter bank span the complete spectrum of interest. The filter bank sorts received energy into a number of channels. The energy in each channel is processed to detect which channels contain signals.

A problem with channelized receivers is that they may classify energy in a channel as a detected signal when an input signal in one channel creates a response in other channels. This effect is called “splatter” and can be caused by overlap in the passbands of filters in the filter bank or transient effects associated with fast rise and fall times of waveforms. Transient effects are particularly significant for pulsed or other signals that have a fast rise or fall time.

Spectral overlap of adjacent filters typically leads to crosstalk between adjacent channels. Splatter caused by transients typically affects many channels because of the large number of frequency components in signals with sharp temporal profiles. As a result, discrimination of single or multiple pulsed signals present a particularly difficult problem. Because of these difficulties, “channel arbitration” procedures are required to determine which channels contain input signals, and which contain signals caused by splatter.

Common channel arbitration methods including maximum amplitude determination and channel-invariant threshold approaches. In maximum amplitude methods, the channel with the largest amplitude, or similarly the largest integrated power, is selected. The energy within the selected channel is processed to extract the signal. All other channels are assumed not to contain a signal and are not selected for further processing. This approach identifies single input signals, but is not well suited for detecting multiple simultaneous input signals. Other receivers have used a simple threshold method. In such an approach, channels with detected energy greater than some predetermined threshold are selected, where the threshold value is the same for all channels. The selected channels are further processed to extract signals. Although this approach allows multiple signals to be detected, setting a threshold too high can lead to the incorrect rejection of weak signals in the presence of a strong signal. Setting a threshold too low may lead to incorrectly identifying noise or splatter from another channel as a signal.

A need therefore exists for a method and corresponding channelized receiver architecture which detects incoming signals without the limitations imposed by the aforementioned approaches.

### SUMMARY OF INVENTION

In one aspect, the invention relates to a method of operating a receiver having a plurality of channels. The method comprises determining levels in each of the plurality of channels, computing a threshold for each of the plurality of channels based on the levels in others of the plurality of channels; and selecting at least one channel in which the level exceeds the threshold for that channel.

In another aspect, the invention relates to a method of operating a receiver having a plurality of channels. The method comprises computing a threshold for each of the plurality of channels, the threshold being computed based on the levels in the plurality of channels; detecting signals in the plurality of channels for which the level in the channel exceeds the threshold for that channel; and dynamically updating the threshold in each of the plurality of channels as the levels in the plurality of channels change.

In a further aspect, the invention relates to a receiver having a filter bank with a plurality of outputs. The receiver includes a first circuit having a plurality of inputs coupled to the plurality of outputs of the filter bank. The first circuit has a plurality of outputs each corresponding to one of the plurality of outputs of the filter bank. The first circuit uses values at the plurality of inputs of the first circuit to compute a value of each of the plurality of outputs of the first circuit. The receiver also includes a plurality of comparators, each having at least a first input and a second input. A first input of each comparator is coupled to an output of the filter bank. A second input of each comparator is coupled to an output of the first circuit. Each of the plurality of comparators has an output representative of the relative values at the first input and the second input of the comparator. The receiver additionally includes a selection circuit having at least one output and a plurality of inputs coupled to the outputs of the comparators. The selection circuit provides at the at least one output an indication of at least one of the outputs of the filter bank selected in response to the outputs of the comparators.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a channelized receiver;

FIG. 2 is a flow chart illustrating a method of operation of the receiver in FIG. 1;

FIG. 3 is a block diagram showing the threshold mask generation module of FIG. 1 in greater detail;

FIG. 4 is a block diagram illustrating in greater detail portions of the threshold mask generation module 120 of FIG. 1;

FIGS. 5A, 5B and 5C are sketches useful in understanding the operation of the threshold mask generation module 120 of FIG. 1; and

FIG. 6 is a sketch illustrating the threshold mask generated by the receiver in FIG. 1.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

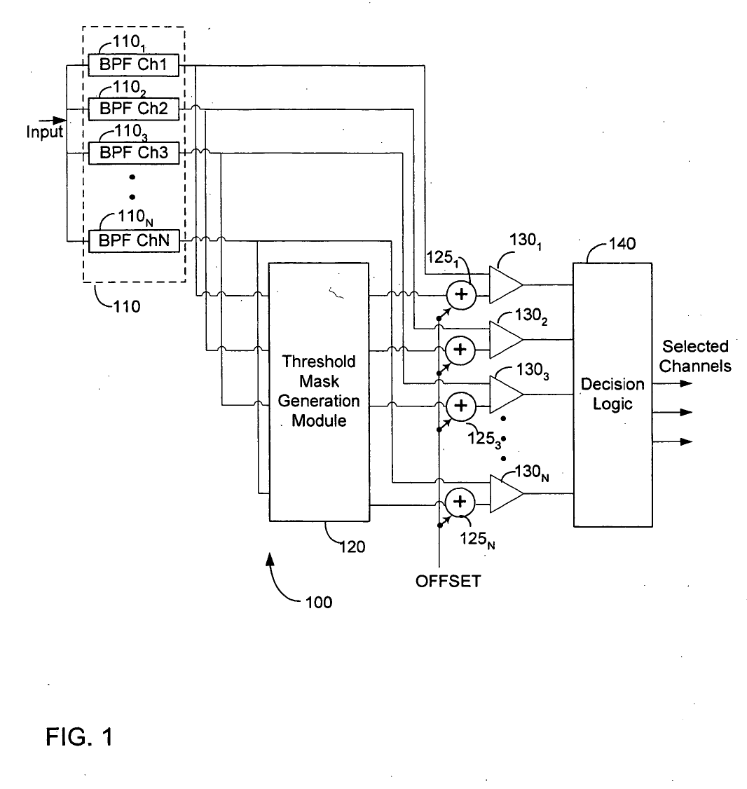

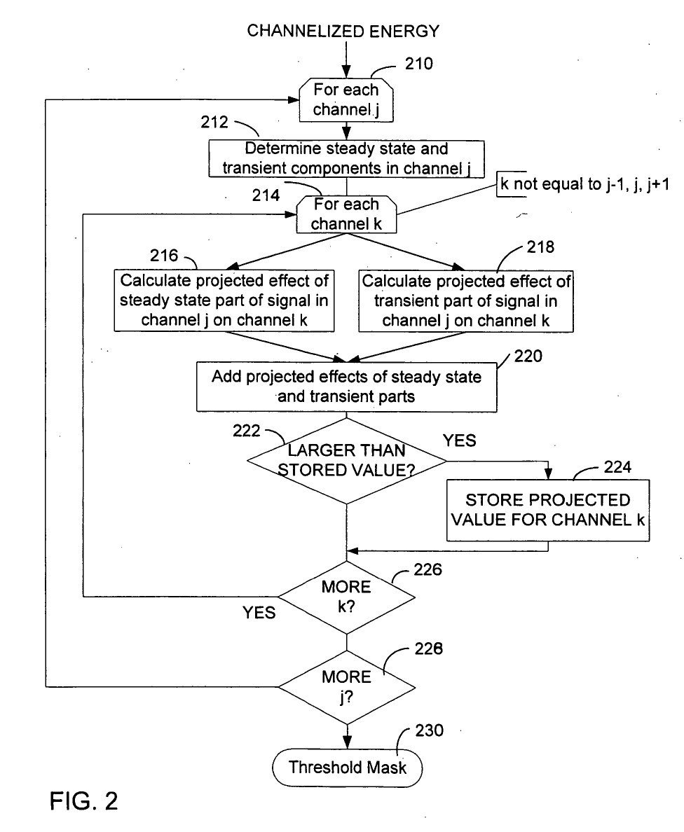

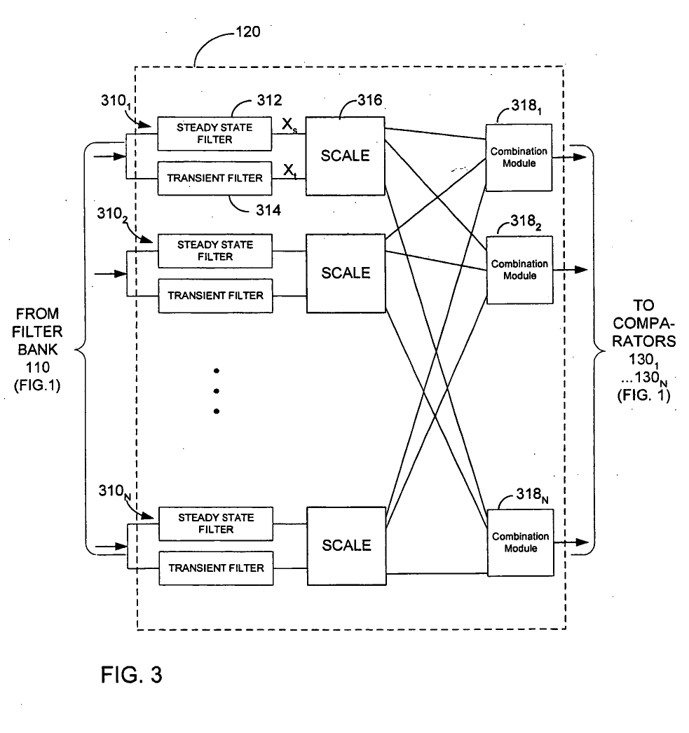

FIG. 1 shows a block diagram of channelized receiver 100. As in a conventional channelized receiver, input energy is provided to a filter bank 110. Filter bank 110 contains multiple bandpass filters 110₁, 110₂ . . . 110_{N}. In the described embodiment, each of the filters in filter bank 110 has a different center frequency, with the filters being ordered in accordance with their center frequencies. Each of the filters 110₁, 110₂ . . . 110_{N} has a passband that partially overlaps the passband of any adjacent filter.

The output of each of the filters in filter bank 110 represents the components of the input having frequencies falling in the passband of that filter. Thus, the output of each filter may be considered as creating a separate channel. The outputs of filter bank 110 are applied to a bank of comparators 130₁, 130₂ . . . 130_{N}. Each of the comparators compares the energy in one of the channels to a threshold. The thresholds are provided by threshold mask generation module 120, which may be adjusted such as with a linear offset added by adders 125₁ . . . 125_{N}.

The operation of threshold mask generation module 120 is described in greater detail below. The threshold mask provided by threshold mask generation module 120 includes a threshold for each of the channels. Each channel may have a different threshold value. Further, in the described embodiments, the threshold mask changes in response to changes in the distribution of energy in the input. Advantageously, the threshold mask changes to increase the likelihood that receiver 100 detects a signal contained in the input. In addition, the threshold mask changes to increase the likelihood that, if a signal is detected, receiver 100 will select the appropriate channel for monitoring that signal.

The threshold mask provided by the threshold mask generation module 120 is altered by the application of an offset in 125₁, 125₂, . . . 125_{N}. This offset may be adjusted up or down to provide a probability of false detection or false alarm that is required by the receiver system. This single point of adjustment is provided as a method of quickly adapting to environments where noise levels are dynamically changing. However, each channel may receive a different offset value which may, for example, be determined from a measurement or estimation of noise in the channel made while the receiver is not connected to the input energy so that the receiver is measuring only noise.

The outputs of the comparators 130₁, 130₂ . . . 130_{N} are provided to decision logic 140. Decision logic 140 processes values generated by comparators 130₁, 130₂ . . . 130_{N} to identify which of the channels contains a signal that should be selected for further processing. Receiver 100 may be employed in a communication system as is known in the art. Processing of the selected channels is based on the desired functionality of the communication system and may be as in the prior art.

Turning to FIG. 2, a method of operation of receiver 100 is illustrated in a flow chart. The method begins at step 210. At step 210 a loop is established such that processing may be performed for each of the channels. FIG. 1 illustrates N channels. A typical channelized receiver may have, for example, 8 to 512 channels. However, the number of channels is not a limitation on the invention and the symbol N will be used to denote the number of channels.

In setting a threshold, the energy in channel j is postulated to represent a signal in channel j—as opposed to “splatter” from a signal in another channel. The steady state and transient component of this postulated signal in channel j are determined at step 212.

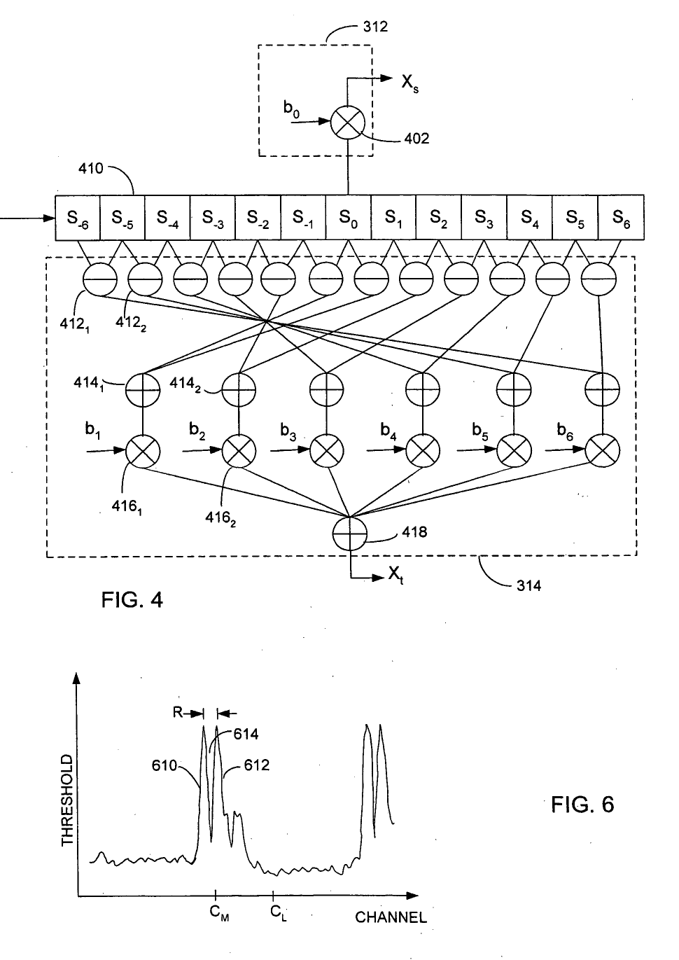

An example of determining steady state and transient components is given below in connection with FIG. 3 and FIG. 4. In that example, the energy in channel j is filtered with separate filters to output a steady state and transient component.

The method proceeds at step 214. At step 214, a loop is established for each channel, indexed by the value k. In the subsequent steps, the impact that the energy in channel j will have in channel k is estimated. Because the value of k changes each pass through the loop, the effect of the postulated signal in channel j on every other channel of interest is computed by multiple iterations through the loop. In the described embodiment, no estimate is made of the effect of a postulated signal in any channel on that same channel. For that reason, the loop established at step 214 excludes values where k=j. Further, because there is often overlap in the spectral coverage of each channel, in the described embodiment, the loop established at step 214 also excludes channels that immediately proceed and immediately follow channel j. Thus the loop established at step 214 includes values of k from 1 to N except k=j−1, j and j+1.

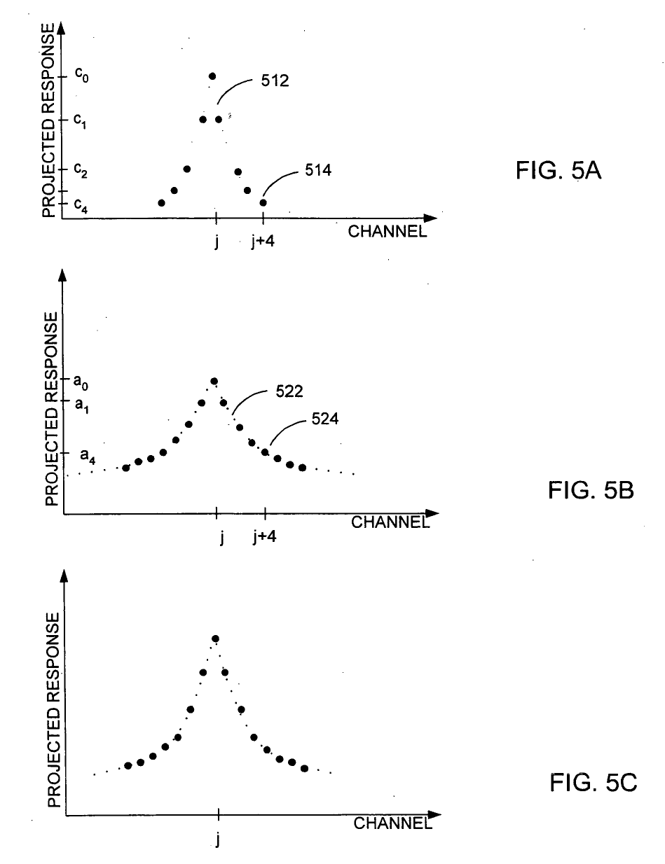

At step 216, a projection is made of the effect in channel k from the postulated signal in channel j. FIG. 5A illustrates how this calculation may be made. FIG. 5A shows an interchannel transfer function 512. The interchannel transfer function 512 represents the magnitude of energy induced in each channel from a steady state signal of unit value in channel j. The coefficients of the interchannel transfer functions may be determined empirically. Alternatively, coefficients may be determined by simulating the operation of the receiver or by any other convenient circuit analysis technique.

The value c₄ at 514 illustrates the expected response in channel j+4 from a steady state signal of unit magnitude in channel j. By scaling the value c₄ by the steady state component determined at step 212 by, the projected effect of a steady state signal in channel j that should be observed in channel j+4 can be determined. Thus at step 216, when k=j+4, the projected value in channel k is calculated by multiplying the value c₄ by the steady state component for channel j computed at step 212.

At step 218 a similar computation is performed for the transient part of the postulated signal. FIG. 5B illustrates an interchannel transfer function 522. This transfer function represents the response to a transient signal of unit magnitude in channel j. In particular, the value 524 represents the response that will be induced in channel j+4 from a transient signal in channel j. The projected value of the transient signal in channel k can be computed by multiplying the value 524 by the postulated transient component in channel j computed at step 212.

Processing proceeds at step 220. The projected response in any channel k is a combination of the steady state and transient responses. Therefore, the values projected at steps 216 and 218 are combined at step 220. These values may be combined through simple addition. FIG. 5C represents the combination of the steady state and transient responses depicted in FIGS. 5A and 5B.

Processing proceeds to step 222. In the method illustrated in FIG. 2, a signal is deemed to be detected if the energy in a channel exceeds the projected effect of a signal in any other channel. To implement the method, it is not necessary to store the results of the computation of the effect of a postulated signal from every other channel. Rather, it is sufficient to store, for each channel k, the one value corresponding to the largest effect from a postulated signal in any other channel. At step 222 a check is made as to whether the projected effect in channel k from a signal in channel j is larger than a stored value representing the effect projected in channel k from another channel. If the postulated signal in channel j is projected to create a larger effect in channel k than the stored value, processing proceeds to step 224. The larger value is stored, replacing the smaller value. If the postulated signal in channel j is projected to create a smaller effect in channel k than postulated signals in any prior iteration of the loop, processing proceeds to step 226 without changing the stored value for channel k.

At step 226 a check is made whether the effect of the postulated signal in channel j has been computed for all channels k. If not, the processing returns to step 214 for another iteration through the loop comprising steps 216, 218, 220, 222 and 224.

If the projected effect from the postulated signal in channel j has been computed for every other channel, processing proceeds to step 228. At step 228 a check is made as to whether postulated signals in every channel have been considered. If more channels j remain to be considered, processing loops back to step 210. Another iteration is performed with the next channel, postulating that the energy in that channel represents a signal in that channel.

When postulated signals have been considered in all of the channels j, the process illustrated in FIG. 2 ends at step 230. At step 230, the threshold mask is available. The threshold mask consists of the stored value for every channel k. The stored value for each channel represents the largest projected impact in that channel from postulated signals in all of the other channels. If the detected energy in a channel exceeds the threshold for that channel, then it is likely that the energy in that channel represents a signal rather than splatter from a signal in another channel.

In the described embodiment, the process of FIG. 2 is performed continuously throughout operation of receiver 100. The postulated signals in each of the channels changes as the energy levels in each of the channels changes. Therefore, the computed threshold may be different for each sample of the input to the receiver.

If processing capacity permits, new values for the threshold mask may be computed once for each sample of the input. Preferably, a new threshold mask will be computed at intervals that are short in comparison to the duration of the signals that may be detected by receiver 100. For example, a complete set of values in the threshold mask may be computed for every 20 samples of the input. For this configuration, only a portion of the process illustrated in FIG. 2 would be completed for each sample of the input.

Turning to FIG. 3, the details of an embodiment of threshold mask generation module 120 (FIG. 1) are shown. The outputs of filter bank 110 are applied as an input to threshold mask generation module 120. Each input is applied to a channel circuit such as 310₁, 310₂, . . . 310_{N}.

Taking channel circuit 310₁ as illustrative, the input signal is applied to both a steady state filter 312 and a transient filter 314. Further details of filters 312 and 314 are provided below in connection with FIG. 4. Steady state filter produces an output, Xₛ representing the steady state component of the input to that channel. Transient filter 314 produces and output, Xₜ, representing the transient component of the input to that channel.

The filter outputs Xₛ and Xₜ are applied to a scaling circuit 316. In one embodiment, scale circuit 316 contains memories that store the coefficients of the interchannel transfer functions such as were illustrated in connection with FIGS. 5A and 5B. Scale circuit 316 may include multipliers that multiply the steady state component Xs by the coefficients of the steady state interchannel transfer function and multiply Xt by the coefficients of the interchannel transfer function for the transient response. Once scaled by the transfer function coefficient, the steady state and transients component of the response for each channel are added and provided as an output of scale circuit 316.

The outputs of the scale circuit 316 in channel circuit 310₁ are the projections of the response to the postulated signal in channel one in each of the other channels. The outputs of scale circuit 316 in channel circuit 310, are the projections of the response from the energy detected in channel 2 in each of the other channels. Likewise, the outputs of the scale circuit in each of the other channel circuits are the projections of the responses to the postulated signal in the respective channel in each of the other channels. Where the scale circuits 316 implement the method of FIG. 2 each scale circuit 316 sets the projected value 0 for its respective channel and any adjacent channel.

Each channel circuit has a combination module such as 318₁, 318₂ . . . 318_{N} associated with it. The output of each of the combination modules 318₁, 318₂ . . . 318_{N} forms the threshold for the associated channel. The outputs of combination modules 318₁, 318₂ . . . 318_{N} collectively form the threshold mask. The projection of the response in each channel computed by the scale circuits, such as 316, is routed to the combination module for the channel in which the response is projected. For example, the output of scale circuit 316 in each of the channel circuits 310₁ . . . 310_{N} projecting an effect in channel one is routed to combination module 318, associated with channel one. Projected effects in all the other channels are routed to the combination module for the respective channel. When threshold mask generation module 120 performs according to the algorithm illustrated in FIG. 2, each combination module such as 318₁, 318₂ . . . 318_{N} provides as an output the largest value at its inputs.

Turning now to FIG. 4, additional details of the steady state filter 312 and transient filter 314 are shown. In the illustrated embodiment, each of the filters is implemented as a finite impulse response filter. To implement the filters, samples of the signal in each channel are shifted through shift register 410. In this embodiment, shift register 410 is shown to have 13 stages numbered S₋₆ . . . S₀ . . . S₆. Each stage stores a sample of the input at a successively later period in time. In a contemplated embodiment, the values Xₛ and Xₜ are used to create the threshold mask that is applied when the value of the input stored in storage S₀ is compared to the threshold. As shown in FIG. 4, the steady state component Xₛ is computed by multiplying the value S₀ by a coefficient b₀. Preferably, b₀ is stored in a register or other memory element. Multiplier 402 is connected as shown to produce the product of S₀ and b₀.

Transient filter 314 includes multiple levels of arithmetic circuitry. At the first level, difference circuits (of which only 412₁ and 412₂ are numbered for simplicity) compute the difference between successive samples of the input. Different circuits such as 412₁ and 412₂ in this embodiment compute the absolute value of the difference.

At the second level, adders (of which only 414₁ and 414₂ are numbered for simplicity) combine two of the outputs produced at the first level. Adder 414₁ combines the two center values computed at the first level. Each successive adder at the second level combines the next highest and next lowest difference value computed at the first level.

At the third level, the output of each of the adders at the second level is multiplied by a coefficient b₁, b₂ . . . b₆ in multipliers (of which only 416₁ and 416₂ are numbered for simplicity). As with coefficient b₀, the coefficients b₁, b₂ . . . b₆ may be stored in registers or other convenient memory circuit. The output of each of the multipliers at the third level is combined in an adder 418 making up the fourth level. The output of adder 418 is the output Xₜ of the transient filter 314.

In the embodiment illustrated, the same set of coefficients b₀ . . . b₆ is used in each of the channel circuit 310₁, 310₂ . . . 310_{N} Specific values for these coefficients may be determined empirically or according to any known method for filter design and the values need not be the same for every channel.

Turning to FIG. 6, an example of a threshold mask is provided. FIG. 6 shows that for each channel, a separate threshold level may be set. FIG. 6 shows the threshold mask as a continuous curve. However, it should be appreciated that for a discrete number of channels, the threshold mask is a series of discrete values. Advantageously, the threshold in channel C_{M} is higher than the threshold in channel C_{L}. In this way, receiver 100 may detect a relatively low level signal in channel C_{L} even though a much higher threshold has been set for greater noise and splatter immunity in channels in the vicinity of channel C_{M}.

FIG. 6 also illustrates an additional step that may be employed with the method of FIG. 2. As described, the projected effect of a postulated signal in a channel is not used in computing the threshold for that channel or adjacent channels. In the case where a relatively large amount of energy in a channel leads to a large postulated signal in a channel, the projected effect of that postulated signal in nearby channels may be relatively large. A large projected effect results in a relatively high threshold. Such as is illustrated by peaks 610 and 612. However, because that large postulated signal is not used in computing threshold values in that or adjacent channels, a notch 614 may appear in the threshold mask. Because of this notch, and because of the potential overlap in the frequency range of the bandpass filters in filter bank 110, an input signal, even though of a single frequency, may produce a measurable output in several adjacent channels over a range such as R. In one embodiment, decision logic 140 may be constructed to select a single one of the adjacent channels. In one embodiment, decision logic 140 selects the channel having the most stable phase from sample to sample and does not select other channels in range R even though they exceed the thresholds set for those channels.

Having thus described several aspects of at least one embodiment of this invention, it is to be appreciated various alterations, modifications, and improvements will readily occur to those skilled in the art.

For example, the above described embodiments employed digital logic to form threshold mask generation module 120 and decision logic 140. The processing functions described above may alternatively be provided with analog circuitry.

Similarly, filter bank 110 may be implemented as a bank of analog filters. Alternatively, a filter bank may be formed using digital circuitry. For example, the input may be sampled and transformed using a FFT or similar frequency domain transform.

Further FIG. 2 shows a flow chart that illustrates a method of operation. The flow chart illustrates steps occurring sequentially. However, a similar result can be achieved by performing many of the operations simultaneously. For example, the values for each channel k may be computed simultaneously.

Further, various functions are shown to be implemented in single circuits, but alternative partitioning of circuits is possible. As an example of a single circuit element that could be implemented as multiple components, FIG. 4 shows a single shift register used to implement both filter 312 and 314. Separate shift registers could be used. As an example of multiple elements that may be implemented as one circuit, FIG. 3 shows separate circuits that perform filtering, scaling and combining operations. This partitioning is not essential. Filtering and scaling may be performed by the same circuit. Scaling and combining may alternatively be performed by the same circuit. As a further example, in implementation, one or more channel circuits may be implemented in one or more digital signal processing chips.

Further the same interchannel transfer function is shown for all channels. In some instances, it may be desirable to use a different interchannel transfer function for different channels. For example, if some channels have larger pass bands than others or different frequency rolloffs, different interchannel transfer functions may be employed. Likewise, each interchannel transfer function is shown to be symmetrical. Different frequency responses in different channels may result in a non-symmetric distribution.

As a further example, the specific values used in computations, such as values of the interchannel transfer functions c₀, c₁, c₂ . . . and a₀, a₁, a₂ . . . are described to be determined empirically. Likewise, filter coefficients b₀ . . . b₆ are described to be determined empirically. However, such values may be determined by mathematical modeling or in any convenient way.

Further, the filter shown in FIG. 4 is one example of a filter architecture. Many other filters, including IIR filters, may be used.

Further, it is described that when incident energy results in a response in multiple contiguous channels, the detected signal with the greatest phase stability is selected further processing. Other methods of selecting one of the signals may be employed, such as selecting the signal in the middle channel.

As a further variation, it is described that combination modules 318₁ . . . 318_{N} operate by selecting the largest projected effect in a channel. However, other methods of selecting a threshold may be employed. For example, the projected effects from some or all of the other channels may be added together to form the threshold.

Such alterations, modifications, and improvements are intended to be part of this disclosure, and are intended to be within the spirit and scope of the invention. Accordingly, the foregoing description and drawings are by way of example only.

What is claimed is:

1. A method of operating a receiver having a plurality of channels, the method comprising:
a) determining levels in each of the plurality of channels;
b) computing a threshold for each of the plurality of channels based on the levels in others of the plurality of channels; and
c) selecting at least one channel in which the level exceeds the threshold for that channel.

2. The method of claim 1 additionally comprising:
a) determining levels in each of the plurality of channels at a subsequent time;
b) computing an updated threshold for each of the plurality of channels based on the levels in the others of the plurality of channels at the subsequent time; and
c) selecting at least one channel in which the level exceeds the updated threshold for that channel.

3. The method of operating a receiver of claim 1 wherein computing a threshold for a first channel comprises:
a) for at least a subset of the plurality of channels, computing the effect in the first channel of a signal in each of the channels in the subset; and
b) selecting as the threshold for the first channel the value of the largest computed effect in the first channel.

4. The method of claim 3 wherein computing the effect in the first channel from a signal in a second channel within the subset comprises:
a) computing, based on the determined level in the second channel, a steady state component and a transient component in the first channel;
b) combining the steady state component and transient component.

5. The method of claim 4 wherein computing a steady state and transient component comprises:
a) filtering values representing the levels in the second channel to produce a postulated transient signal in the second channel;
b) filtering values representing the levels in the second channel to produce a postulated steady state signal in the second channel;
c) scaling the postulated transient signal by a first inter-channel transfer function to produce a computed transient component; and
d) scaling the postulated transient signal by a second inter-channel transfer function to produce a computed steady state component.

6. The method of claim 3 wherein the channels are ordered in accordance with their pass bands and the subset comprises the plurality of channels excluding a group of contiguous channels including the first channel.

7. The method of claim 6 wherein selecting channels comprises identifying contiguous channels in which the level exceeds the threshold and selecting one of such contiguous channels based on phase stability characteristics of the detected signals in those channels.

8. The method of claim 1 wherein computing a threshold for each of the plurality of channels comprises:
a) computing an offset value based on noise to which the receiver is exposed; and
b) computing a threshold that is a combination of the offset value and a value based on the others of the plurality of channels.

9. A method of operating a receiver having a plurality of channels with a level of energy in each of the channels, the method comprising:
a) computing a threshold for each of the plurality of channels, the threshold being computed based on the levels of energy in the plurality of channels;
b) detecting a signal in at least one of the plurality of channels for which the level of energy in the channel exceeds the threshold for that channel; and
c) dynamically updating the threshold in each of the plurality of channels as the levels of energy in the plurality of channels change.

10. The method of claim 9 wherein computing a threshold for a first channel comprises:
a) providing at least one scale factor between the level of energy in a second channel and the level of energy in the first channel
b) detecting the level of energy in the second channel;
c) using the scale factor and the detected level of energy in the second channel to compute a threshold in the first channel.

11. The method of claim 10 wherein providing a scale factor comprises providing at least two scale factors and detecting the level of energy in the second channel comprises selecting the level of at least two components in the second channel and computing a threshold comprises combining the products of scale factors and levels of components.

12. The method of claim 9 additionally comprising:
a) providing for each channel in a subset of the plurality of channels, at least one scale factor between the level of energy in a channel in the subset and the level of energy in a first channel;
b) detecting the levels of energy in channels in the subset;
c) using the scale factors and the detected levels of energy in the channels in the subset to compute a projected effect in the first channel from energy in each of the channels within the subset; and
d) selecting as the threshold for the first channel the largest computed effect in the first channel from energy in any of the channels in the subset.

13. The method of claim 12 wherein providing the scale factors comprises empirically determining values of an inter-channel transfer function of the receiver.

14. The method of claim 9 wherein computing a threshold for a first channel further comprises adding an offset value representative of noise in the first channel.

15. A receiver, comprising:
a) a filter bank having a plurality of outputs;
b) a first circuit having a plurality of inputs coupled to the plurality of outputs of the filter bank, the first circuit having a plurality of outputs each corresponding to one of the plurality of outputs of the filter bank, the first circuit using values at the plurality of inputs of the first circuit to compute a value of each of the plurality of outputs of the first circuit;
c) a plurality of comparators each having at least a first input and a second input, with a first input of each comparator coupled to an output of the filter bank and a second input of each comparator coupled to an output of the first circuit and each of the plurality of comparators having an output representative of the relative values at the first input and the second input of the comparator; and
d) a selection circuit having at least one output and a plurality of inputs coupled to the outputs of the comparators, the selection circuit providing at the at least one output an indication of at least one of the outputs of the filter bank selected in response to the outputs of the comparators.

16. The receiver of claim 15 wherein the first circuit comprises a plurality of channel circuits, each having an input coupled to an output of the filter bank, each channel circuit comprising:
a) a first filter, coupled to the input of the channel circuit, the first filter having an output providing a first filter output;
b) a second filter, coupled to the input of the channel circuit, the second filter having an output providing a second filter output;
c) a scaling circuit, receiving the output of the first filter and the output of the second filter, the scaling circuit having a plurality outputs each representing an arithmetic operation on the output of the first filter and the second filter.

17. The receiver of claim 16 wherein the first circuit additionally comprises a plurality of sub-circuits, each sub-circuit having a plurality of inputs, each coupled to an output from a scaling circuit in one of the plurality of channel circuits, each sub-circuit having an output computed in response to the inputs of the sub-circuit, each output of the sub-circuit providing an output of the first circuit.

18. The receiver of claim 16 wherein each of the first filters and the second filters is a digital filter.

19. The receiver of claim 16 wherein each output of each scaling circuit is a linear combination of the output of the first filter and the second filter.

20. The receiver of claim 19 wherein each of the scaling circuits stores a plurality of coefficients, and each output comprises the sum of the output of the first filter multiplied by one of the coefficients and the output of the second filter multiplied by a second coefficient.
